(19) United States
(12) Patent Application Publication
(10) Pub. No.: US 2015/0286700 A1
(43) Pub. Date: Oct. 8, 2015

(54) RECORDING MEDIUM HAVING STORED THEREON DATABASE ACCESS CONTROL PROGRAM, METHOD FOR CONTROLLING DATABASE ACCESS, AND INFORMATION PROCESSING APPARATUS

(71) Applicant: FUJITSU LIMITED, Kawasaki-shi (JP)

(72) Inventors: Mingxin Wang, Numazu (JP); HISAYUKI ENBUTSU, Numazu (JP); MAKOTO SUZUKI, Numazu (JP)

(21) Appl. No.: 14/664,955

(22) Filed: Mar. 23, 2015

(30) Foreign Application Priority Data
Apr. 4, 2014 (JP) 2014-078214

(51) Int. Cl. G06F 17/30; G06F 7/24

(52) U.S. Cl. CPC G06F 17/30595; G06F 7/24; G06F 17/30415; G06F 17/30368

(57) ABSTRACT

An information processing apparatus acquires first manipulation information formed by a first data manipulation language for a plurality of record types on which a data manipulation is to be performed, in an NDB having a data structure in which a parent-child relationship is formed between record types, analyzes a relationship between the plurality of record types by using relationship definition information in which item information, parent identifying information and child ordering information are defined for each record type, generates second data manipulation information formed by a second data manipulation language for the NDB, on the basis of the analyzed relationship and the first manipulation information, and outputs the generated second data generation information to the NDB.

### CROSS-REFERENCE TO RELATED APPLICATION

This application is based upon and claims the benefit of priority of the prior Japanese Patent Application No. 2014-078214, filed on Apr. 4, 2014, the entire contents of which are incorporated herein by reference.

### FIELD

The present invention relates to an access control to a database.

### BACKGROUND

The number of engineers who deal with network-type databases (NDB) has been decreasing with developments in open technology. Under such circumstances, several methods to realize maintenance and operation of existing assets of a mainframe NDB (NDB resources) by use of open technology have been developed.

However, those methods do not permit a manipulation to be performed along with consideration of a record order, which is a feature of the NDB, or only permit a realization of a portion of the functions under strict conditions. Amore widely used and practical access method which permits taking advantage of the NDB by use of an SQL as an open interface is required.

For example, as a first technology, a technology is provided which permits searching and updating of a hierarchical network-type database system, treating it as a relational database (for example, Patent Document 1). According to the first technology, an input query statement which gives an instruction on the conditions for searching, updating, adding, and deleting, for example, is analyzed by use of analysis means. For records having individual fields which are obtained as a first output from a result of the analysis and which are related to the conditions in question, a record relation tree which represents a relation between the records is generated by connection means and stored in storage means. Further, for operators obtained as a second output from the above result of the analysis and forming a binary operation whose sets are obtained by a break-down of the conditions in question, a condition tree having the operators as a node is generated by the connection means, and an array of access blocks which indicates a condition and a procedure for accessing a hierarchical network-type database on the basis of the record relation tree and the condition tree is generated by generation means. The array of blocks is interpreted and executed successively by execution means.

As a second technology, a technology is provided which permits processing so as to add a record corresponding to the meaning that a record linking order has in an NDB when an operation interface by use of an SQL language is provided to a network-type database system (for example, Patent Document 2).

As a third technology, a technology for performing the following processing is provided (for example, Patent Document 3). The third technology permits specifying of connecting of tables by use of an SQL statement between the tables that are derived from parent-child records even if a search key which is unique in a database does not exist in the parent record, and further permits a high-speed access by use of a set to perform table connecting processing.

As a fourth technology, a technology is provided which permits integrally managing application processing so as to access a network database and a relational database (for example, Patent Document 3). According to the fourth technology, the database system has pointer data specific to respective lines of each table that includes data, and is provided with a data table and an order relationship table. The data table stores therein the pointer data together with the data. The order relationship table stores therein a hierarchical relationship in a network database and an order relationship between records on the basis of the pointer data. A database system builds up into an SQL instruction, by use of SQL instruction building-up means, a DML instruction for application processing to access the network database so that the data table is accessed through the order relationship table.
Patent Document 1: Japanese Laid-open Patent Publication No. 04-299459
Patent Document 2: Japanese Laid-open Patent Publication No. 2001-273178
Patent Document 3: Japanese Laid-open Patent Publication No. 06-282576
Patent Document 4: Japanese Laid-open Patent Publication No. 2001-325133

### SUMMARY

An information processing apparatus according to an aspect of the present invention performs the following processes. The information processing apparatus acquires first manipulation information formed by a first data manipulation language for a plurality of record types on which a data manipulation is to be performed, in a network-type database having a data structure in which a parent-child relationship is formed between record types. The information processing apparatus analyzes a relationship between the plurality of record types by use of relationship definition information which was acquired from a storing unit storing therein the relationship definition information. In the relationship definition information, item information which is included in the record types, parent information which identifies a parent record whose record type is a parent record type of the record types, and ordering information which indicates an order of child records that belong to the parent record are defined for each record type. The information processing apparatus generates second data manipulation information formed by a second data manipulation language for the network-type database, on the basis of the analyzed relationship and the first manipulation information. The information processing apparatus outputs the generated second data manipulation information to the network-type database.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B illustrate a problem when a record in an NDB is accessed by use of an SQL applying a first technology;

FIGS. 2A to 2D are illustrations of an NDB in which a relationship between two record types is a “1:1” relationship;

FIGS. 3A to 3D are illustrations of a virtual table according to this embodiment;

FIG. 4 is an example of an information processing apparatus according to the embodiments;

FIG. 5 is an example of a block diagram of an information processing apparatus according to the embodiment (example 1);

FIG. 6 is an example of an SQL-DML conversion table according to the embodiment (example 1);

FIGS. 7A and 7B are illustrations of a data structure of an NDB when a plurality of child record types exist for one parent record type according to the embodiment (example 1);

FIG. 8 is an example of a virtual table definition corresponding to each record type in FIG. 7;

FIGS. 9A to 9C are examples of virtual tables which are recognized on a user side on the basis of the virtual table definition in FIG. 8;

FIG. 10 is an example of an SQL for performing a data manipulation on the virtual tables according to the embodiment (example 1);

FIG. 11 is an example of a result of a query to an NDB by use of the SQL according to the embodiment (example 1);

FIG. 12 is a flowchart of an operation procedure according to the embodiment (example 1);

FIG. 13 is an example of a detailed flowchart of virtual table definition generating processing (S4) according to the embodiment (example 1);

FIG. 14 is an example of a flowchart of query processing to an NDB according to the embodiment (example 1);

FIG. 15 is an example of a flowchart of SQL-DML conversion processing (S33) according to the embodiment (example 1);

FIGS. 16A and 16B are illustrations of a data structure of an NDB when a plurality of child record types exist for a plurality of parent record types according to the embodiment (example 2);

FIG. 17 is an example of a detailed flowchart of virtual table definition generating processing (S4) according to the embodiment (example 2);

FIGS. 18A and 18B are an example of a virtual table definition which is generated in the case of the relationship “parent record type:child record type”=“N:N” according to the embodiment (example 2);

FIGS. 19A to 19D are examples of virtual tables which are recognized on a user side on the basis of the virtual table definition in FIGS. 18A and 18B;

FIG. 20 is an example of an SQL for performing a data manipulation on the virtual tables according to the embodiment (example 2);

FIG. 21 is an example of a result of a query to an NDB by use of the SQL according to the embodiment (example 2); and

FIG. 22 is an example of a configurative block diagram of a hardware environment of a computer which executes a program in the embodiment (examples 1 and 2).

### DESCRIPTION OF EMBODIMENTS

However, according to the first to fourth technologies, the data structures of NDBs on which a data manipulation can be performed by an SQL are limited. Thus, a data manipulation cannot be performed on a NDB without awareness of a relationship of record types or a number of items, as can be done in a data manipulation on a relational database by an SQL.

An aspect of the present invention provides a technology for a database access control which permits increasing of a freedom of a data manipulation on an NDB by an SQL.

The embodiment will now be described in detail.

The first technology permits extracting necessary items of records in an NDB and making them look as if they formed one table of a relational database (RDB) so that searching, updating, adding, and deleting can be performed by an SQL.

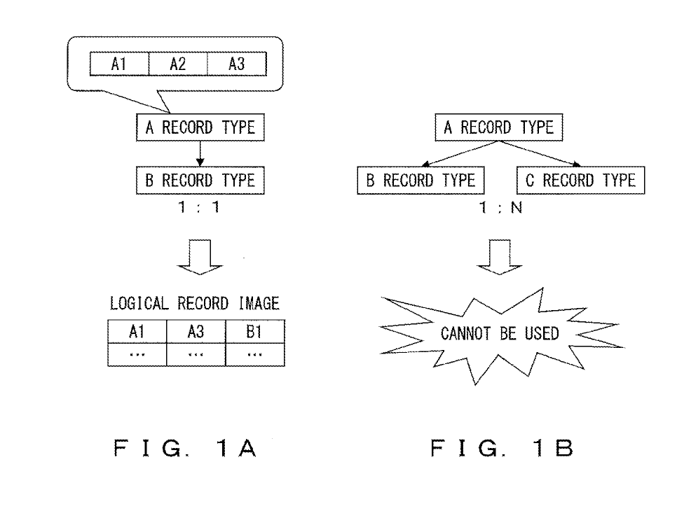

However, the first technology only allows the SQL to access the preset items. For example, it is assumed that an A-record-type record includes items A1, A2, and A3, as illustrated in FIG. 1A. When A1, A3, and B1 are extracted to form a virtual table image, A2 cannot be manipulated by an SQL.

Further, the first technology only permits dealing with a “1:1” relationship in the NDB for a relationship between record types. Thus, as illustrated in FIG. 1B, the first technology does not permit dealing with a “1:N” (N is an integer greater than or equal to two) relationship in which a plurality of record types are associated with one record type.

Furthermore, according to the first technology, the larger a number of hierarchies and items in the NDB, the larger a size of a generated logical record image, with the result that there is a possibility that the logical record image will not be able to be generated because of a limitation on a number of columns in the RDB.

The second technology permits a manipulation to be performed along with consideration of an order in an NDB by presetting a key and sorting in an ascending or descending order. However, the second technology, too, only permits dealing with a “1:1” relationship for a relationship between record types, as is the case in the first technology. Sorting can only be performed on an entire generated virtual table basis, with the result that there is a possibility that a manipulation cannot be performed along with consideration of an order of child records with respect to a specific parent record.

In order to perform operation processing along with consideration of the order correctly, it is necessary that a user understand a structure of the NDB well and designate an appropriate item that serves as a key.

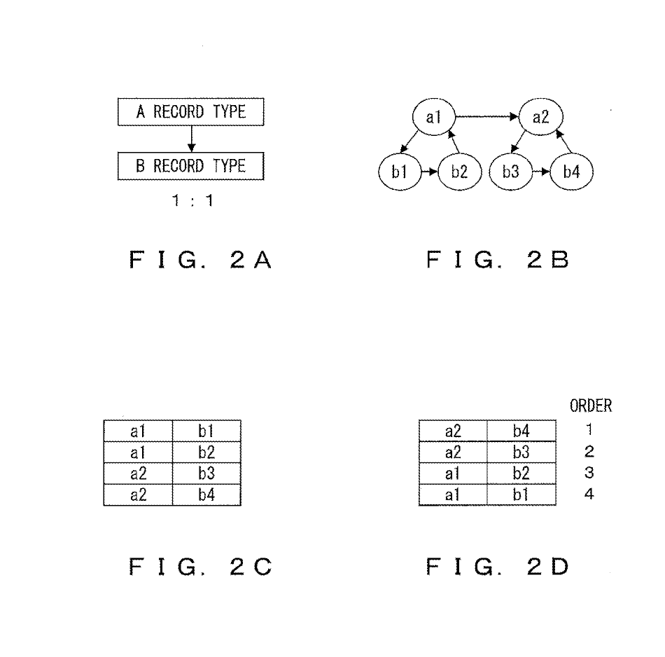

For example, consider an NDB which includes record types A and B and has a data structure in which a relationship between two record types is a “1:1” relationship, as illustrated in FIG. 2A. The record type A includes two records, a1 and a2, and the record type B includes four records, b1, b2, b3, and b4. FIG. 2B illustrates a parent-child relationship between the record types A and B. FIG. 2C is a virtual table which illustrates a combination of the record types A and B. When the item b of the B type is designated as a key in a descending order, the record is sorted and put into order as illustrated in FIG. 2D. This order is not illustrated in an order of item ordering but record ordering.

Further, the second technology may not be suitable for a plurality of usage patterns. For example, in FIG. 2D, if the item b is designated as a key, a manipulation such as an outputting of a record which has a maximum value of b will become easy, but a manipulation such as an updating of a second record of the child records of a1 will become impossible.

According to the third technology, one table is used for one record type and a table joining style is adopted. In the third technology, an item that serves as a key or a unique item or a combination of the items is needed for each record type.

However, in an NDB, a hierarchically highest record often has an entry key, but hierarchically lower child records generally do not have an item that serves as a key or a unique item and it is not possible to use them. In addition, it is necessary for a designer who is familiar with an NDB to participate in selecting the unique item, for example, which results in a workload on him or her.

According to a fourth technology, two tables, a data table and an order relationship table, are generated for each record type in an NDB so as to realize, by their combination, performing a manipulation along with consideration of an order in the NDB. Further, in the fourth technology, pointer data of a parent record, a pointer to the next data record, and a reverse pointer to the data record which points to itself are stored in the order relationship table so as to illustrate an order in the NDB.

However, the fourth technology only permits dealing with a data structure in which a relationship between records is a “1:1” relationship. In the fourth technology, it is assumed that a parent record has essentially been decided. For example, when it is a type of data structure in which a relationship between records is an “n:1” relationship, that is, when there are a plurality of parent records for one child record, it is not possible to determine into which parent record a value is to be put for the item of the pointer data of the parent record.

Further, in the fourth technology, performance when record numbers are specified is bad. The NDB may be used for specifying a record order. For example, when a hundredth record is picked up from an A record type, it is necessary to trace the pointers 99 times from a first record of the A record type, which is not user-friendly.

As described above, there are the following two problems in the first to fourth technologies.

(1) It is not possible to deal with all types of relationships between parent and child record types in an NDB.

For example, as illustrated in FIG. 1B, when a relationship between parent and child record types is a “1:n” type, the B record type is related to (has a relationship with) the A record type, but does not have a relationship with the C record type. Similarly, the C record type is related to (has a relationship with) the A record type, but does not have a relationship with the B record type.

It is not easy to arrange a record type such as the “1:n” type in one table. It may be possible to combine all the B record types with all the C record types, but redundant data will be created, which is not suitable for an RDB specification.

As described above, the first to fourth technologies do not permit dealing with all types of the relationships between the parent and child record types in the NDB.

(2) In order to put records in order, it is necessary for an item that serves as a unique key to exist in the records in an NDB.

For example, by performing sorting with an item that serves as a key, the order in the original NDB can be illustrated by the record order. However, when the item that serves as a key (a unique item) does not exist, that is, when the items whose uniqueness is not ensured are sorted, the records which have the item with the same value may not be in order, depending on the logic of sorting. In this case, the record order may be different from that in the original NDB, which could result in wrong information being represented and at worst in destroying the database.

According to the embodiment, a virtual table definition is generated for each record type. The virtual table definition includes all the items included in the record type, a virtual join key which can identify a parent record, and a virtual order key which indicates what number of a child record in the parent record it is. An information processing apparatus identifies a virtual table name to be manipulated (that is, a record type), on the basis of a table name of an input SQL, and a parent-child relationship between record types on the basis of the virtual join key.

Further, the information processing apparatus has a configuration in which child-record ordering is adjusted by the virtual order key between a virtual relational database which can be seen on a user side and a physical NDB which is actually dealt with on an information-processing apparatus side.

On the other hand, on the user (for example, the designer) side, as is the case in the RDB, the NDB can be used through use of an interface of the RDB without awareness of a data structure of the NDB and an interface of the NDB. This allows the designer to easily develop and maintain business applications without knowing an NDB if he or she has knowledge of an RDB.

In addition, a relationship between record types in the NDB is described by a combination of the virtual join key and the virtual order key. Thus, the record types can be associated without a unique item in the child records if there is a virtual join key. Adopting a join method between virtual tables permits an access to all data in the NDB on a user side by use of a standard SQL.

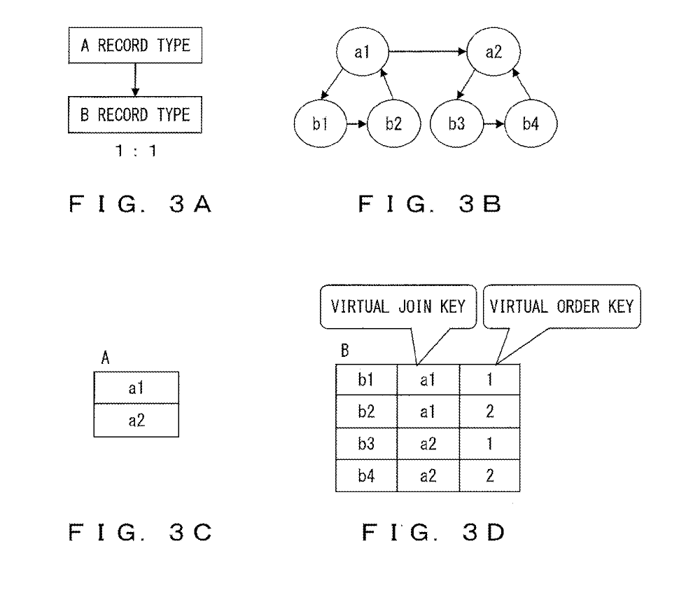

For example, consider an NDB which includes record types A and B and has a data structure in which a relationship between two record types is a “1:1” relationship, as illustrated in FIG. 3A. Since the same as in FIGS. 2A and 2B applies to FIGS. 3A and 3B, the descriptions will be omitted. According to the embodiment, virtual tables illustrated in FIGS. 3C and 3D exist logically for the record types A and B respectively, which have a relationship as illustrated in FIGS. 3A and 3B. The reason for describing “virtual tables exist logically” is that, for the record types A and B, on the user side, the virtual tables A and B look as if they exist, but in reality, they do not exist physically in the information processing apparatus.

For example, in FIG. 3C, when a user wants to manipulate (UPDATE) a second child record of an a1 record, “a1” is designated as a virtual join key, and ‘2’ is designated as a virtual order key. This permits a manipulation of the NDB by use of the standard SQL, which results in solving of the problem in Patent Document 2.

As described above, according to the embodiment, adopting a join method with a virtual join key and a virtual order key permits using of the SQL which is used for a relational database as an interface for the NDB on a user side. In this case, the embodiment are applicable not only to the “1:1” relationship as a relationship between records, but also to all types of relationships between parent and child record types in the NDB.

Further, according to the embodiment, child records can be put into order even if an item that serves as a key in the child records does not exist.

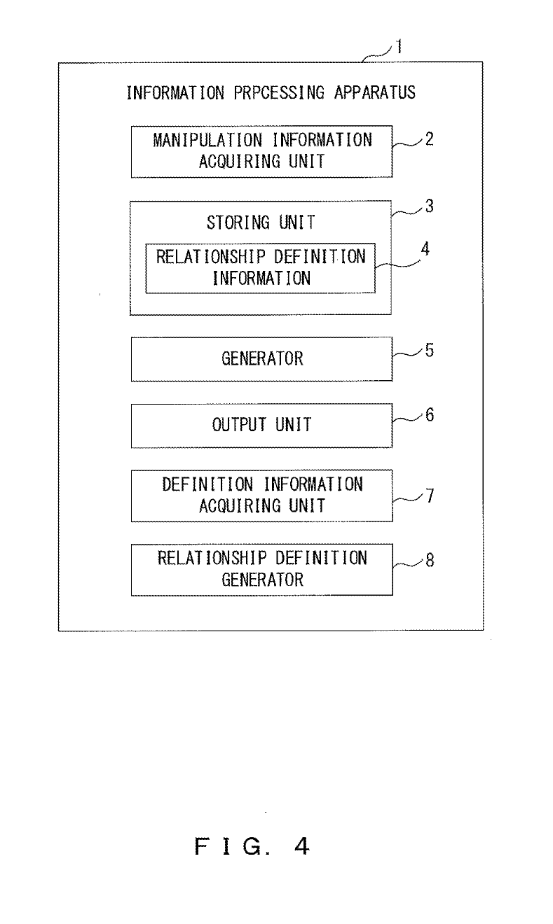

FIG. 4 is an example of an information processing apparatus according to the embodiment. The information processing apparatus 1 includes a manipulation information acquiring unit 2, a storing unit 3, a generator 5, and an output unit 6.

The manipulation information acquiring unit 2 acquires first manipulation information formed by a first data manipulation language for a plurality of record types on which a data manipulation is to be performed, in a network-type database having a data structure in which a parent-child relationship is formed between record types. A reception unit 13 is an example of the manipulation information acquiring unit 2.

The storing unit 3 stores relationship definition information 4. In the relationship definition information 4, item information which is included in the record types, parent information which identifies a parent record whose record type is a parent record type of the record types, and ordering information which indicates an order of child records that belong to the parent record are defined for each record type. A storing unit 19 is an example of the storing unit 3. A virtual table definition 21 is an example of the relationship definition information 4.

The generator 5 analyzes a relationship between the plurality of record types using the relationship definition information 4 which was acquired from the storing unit 3. The generator 5 generates second data manipulation information formed by a second data manipulation language for the network-type database, on the basis of the analyzed relationship and the first manipulation information. A data converter 17 is an example of the generator 5.

The output unit 6 outputs the generated second data manipulation information to the network-type database. A data converter 17 is an example of the output unit 6.

Such a configuration permits increasing of a freedom of a data manipulation on an NDB by an SQL. In addition, the embodiment is applicable to the relationship “parent record type:child record type”=“1:N”.

The information processing apparatus 1 further includes a definition information acquiring unit 7 and a relationship definition generator 8.

The definition information acquiring unit 7 acquires database definition information in which a data structure of the network-type database is defined. A generator 15 is an example of the definition information acquiring unit 7.

The relationship definition generator 8 extracts the item information of the record types for each record type from the acquired database definition information and generates the relationship definition information 4 in which the parent identifying information and child ordering information are added to the extracted item information. A generator 15 is an example of the relationship definition generator 8.

Such a configuration permits generating of a virtual table definition, which allows a virtual existence of a table used for a relational database as an interface on a user side.

When a plurality of parent record types exist as a record type, the relationship definition generator 8 adds the parent identifying information and the child ordering information to the relationship definition information for each parent record type.

Such a configuration permits applying of the embodiment not only to the relationship “parent record type:child record type”=“1:N” but also to the relationship “parent record type:child record type”=“N:N”.

Examples of embodiments will now be described.

### Example 1

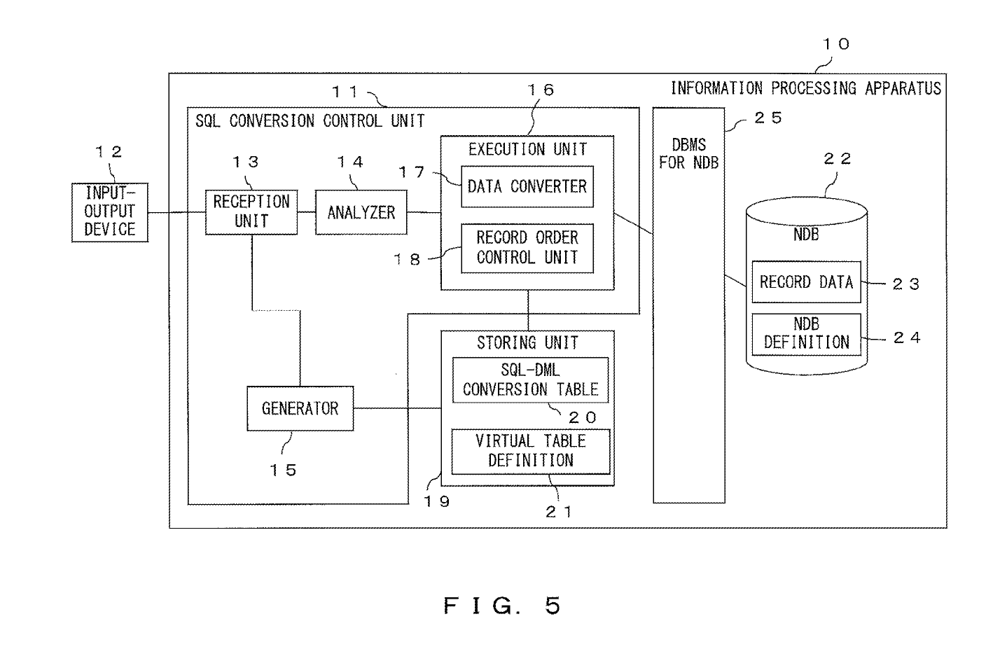

FIG. 5 is an example of a block diagram of the information processing apparatus according to an embodiment (Example 1). An input-output device 12 is connected to the information processing apparatus 10. The input-output device 12 is a general term for input devices such as a keyboard which is used by a user to input an SQL to request a manipulation on an NDB 22 and output devices such as a display.

The information processing apparatus 10 includes an SQL conversion control unit 11, a storing unit 19, the NDB 22, and a database management system (DBMS) for NDB 25. A central processing unit (CPU) of the information processing apparatus 10 reads a program according to the embodiment from the storing unit 19 and executes it so as to function as the SQL conversion control unit 11.

The SQL conversion control unit 11 functions as a reception unit 13, an analyzer 14, the generator 15, and an execution unit 16. The reception unit 13 receives an instruction to create the virtual table definition 21 so that the user will be able to recognize the record types on the NDB as a virtual table, and receives the input SQL.

In response to an instruction from the reception unit 13, the generator 15 generates the virtual table definition 21 for each record type on the basis of an NDB definition 24 read from the NDB 22, and stores the virtual table definition 21 in the storing unit 19.

The analyzer 14 analyzes a syntax of the SQL (such as a SELECT statement, an UPDATE statement, an INSERT statement, and a DELETE statement) that has been received by the reception unit 13.

The execution unit 16 converts the SQL analyzed by the analyzer 14 to a data manipulation language (DML) for NDB and queries the DBMS 25 using the DML for NDB. The execution unit 16 includes the data converter 17 and a record order control unit 18.

The data converter 17 converts the SQL analyzed by the analyzer 14 to the DML for NDB, on the basis of an SQL-DML conversion table 20 and the virtual table definition 21 read from the storing unit. The data converter 17 queries the DBMS 25 using the converted DML for NDB. When receiving from the DBMS 25 data defined in a predetermined form that is used in the NDB 22 (NDB data), the data converter 17 performs the following process on the queries. That is, the data converter 17 converts the NDB data to the data defined in a predetermined form that is used in the RDB (RDB data) (a data-type conversion is included in such a conversion).

When the NDB data is converted to the RDB data by the data converter 17 and the records in the RDB data are output to a virtual table, the record order control unit 18 controls an order of outputting the records.

The storing unit 19 has stored therein, for example, the SQL-DML conversion table 20, the virtual table definition 21, the program according to the embodiment, and other data. The SQL-DML conversion table 20 is a table which is used for mutually converting an SQL and a DML for NDB. The virtual table definition 21 is a table for managing a virtual table structure used in the RDB that is generated for each record type.

The DBMS 25 performs database operation and management for creating the NDB 22. The DBMS 25 accesses the NDB 22 on the basis of a query request by the DML for an NDB given by the execution unit 16 and acquires from the NDB 22 the NDB data according to the query request.

The NDB 22 is a network-type database. The NDB 22 includes record data 23 and the NDB definition 24. The record data 23 is actual data of each of the record types which are held in the NDB 22.

The NDB definition 24 is database definition information on the NDB 22 that is written by use of a database definition language (DDL). The definitions of, for example, the items held in the record types and of the parent-child relationship between record types in the NDB 22 are set in the NDB definition 24.

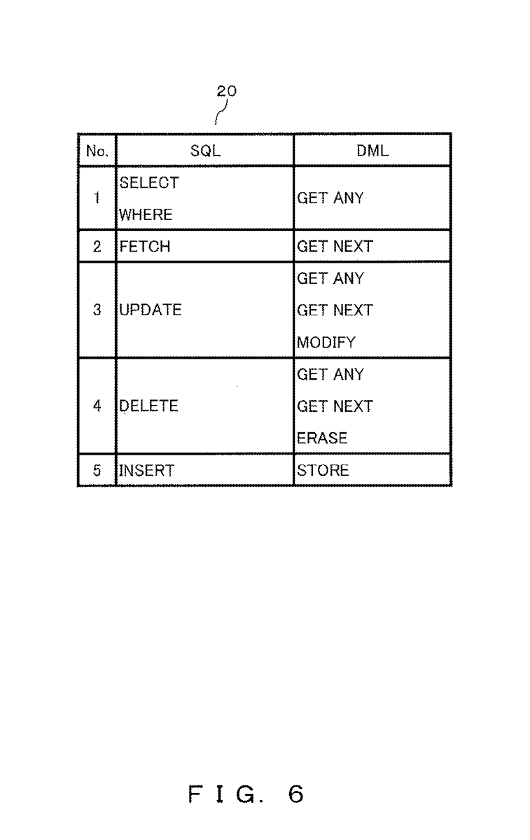

FIG. 6 is an example of an SQL-DML conversion table according to the embodiment (Example 1). The SQL-DML conversion table 20 includes items such as “No.”, “SQL”, and “DML”. The item “No.” has stored therein numbers assigned to each record in the SQL-DML conversion table 20. The item “SQL” has stored therein syntax used in an SQL (such as a SELECT statement, an UPDATE statement, an INSERT statement, and a DELETE statement) that is used in a relational database. The item “DML” has stored therein a DML that is used in a network-type database and that corresponds to the SQL statement that is set to the item “SQL”.

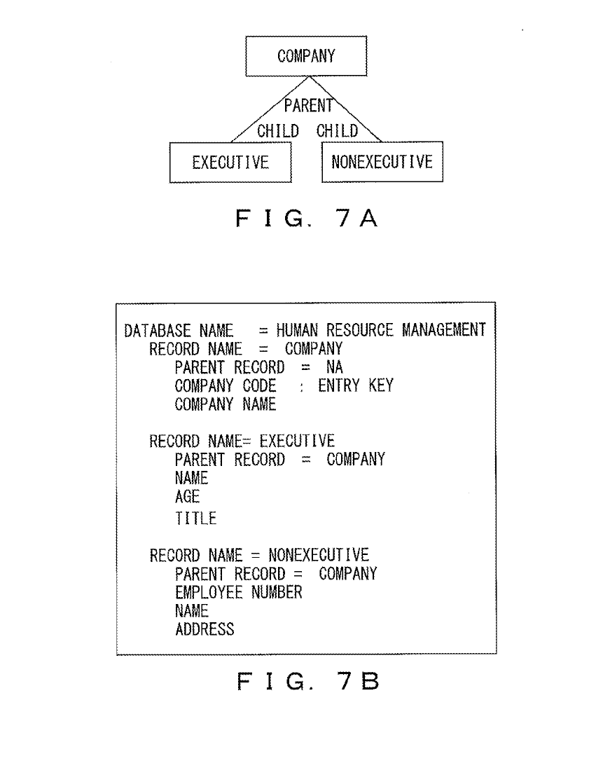

FIGS. 7A and 7B are illustrations of a data structure of an NDB when a plurality of child record types exist for one parent record type according to the embodiment (Example 1). It is assumed that there are two child record types, “EXECUTIVE” and “NONEXECUTIVE”, for a parent record type, “COMPANY”, as illustrated in FIG. 7A.

As illustrated in FIG. 7B, the definition information on the parent record type “COMPANY” and the definition information on the child record types “EXECUTIVE” and “NONEXECUTIVE” are described in the NDB definition 24. Record item information is set to each piece of definition information.

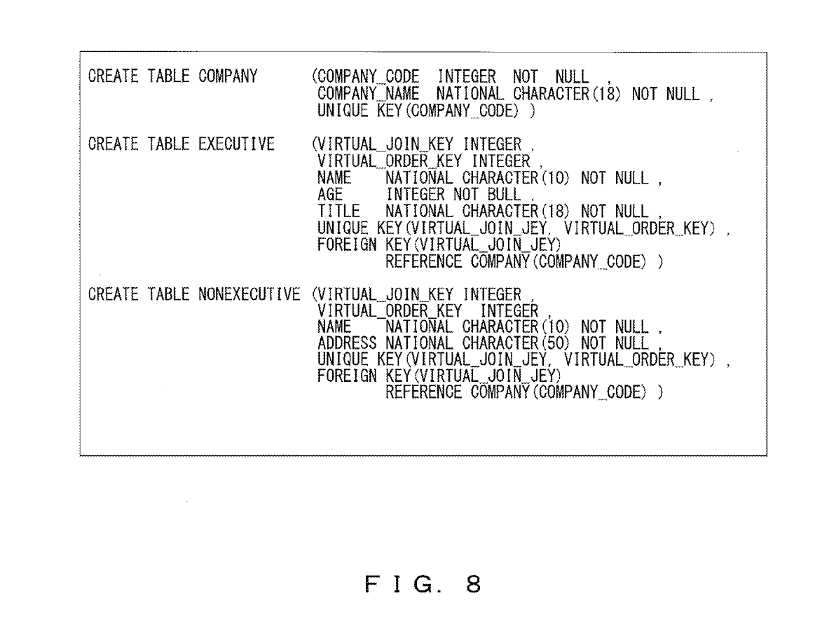

FIG. 8 is an example of a virtual table definition corresponding to each record type in FIG. 7. The generator 15 reads the NDB definition 24, and generates the virtual table definition 21 for each record type. In particular, the generator 15 reads the NDB definition 24 from the NDB 22, acquires the item information from the NDB definition 24 for each record type, and on the basis of the item information, generates the virtual table definition 21 using a definition statement corresponding to a CREATE statement of SQL.

In this case, a virtual join key and a virtual order key are defined as a unique key in the virtual table definition of the child record types. The virtual join key is information on a key for identifying the parent record, which corresponds to a foreign key. In virtual tables “EXECUTIVE” and “NONEXECUTIVE” of FIG. 8, the virtual join key is linked to a company code in a virtual table of the parent record type “COMPANY”. The virtual order key is information on a key for indicating what number of a child record in the parent record it is.

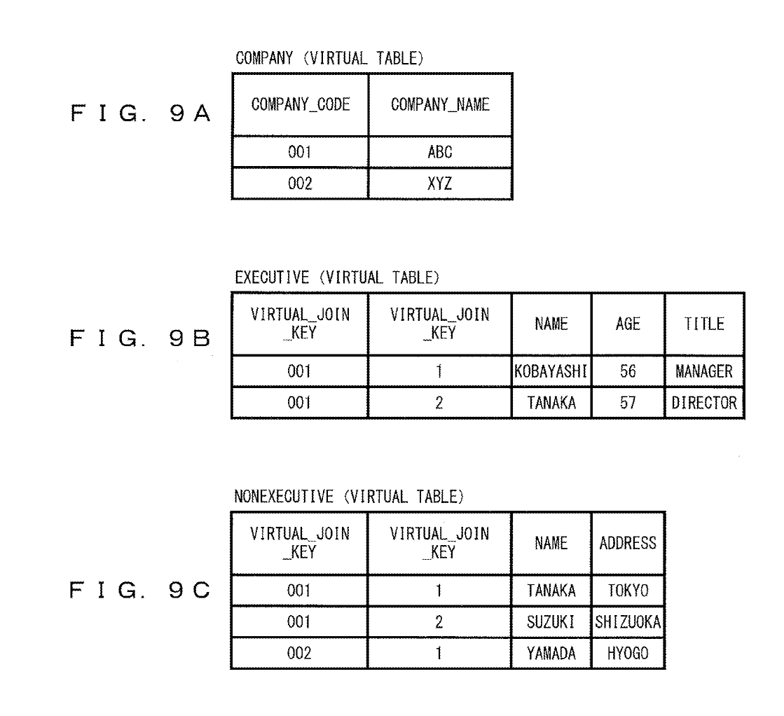

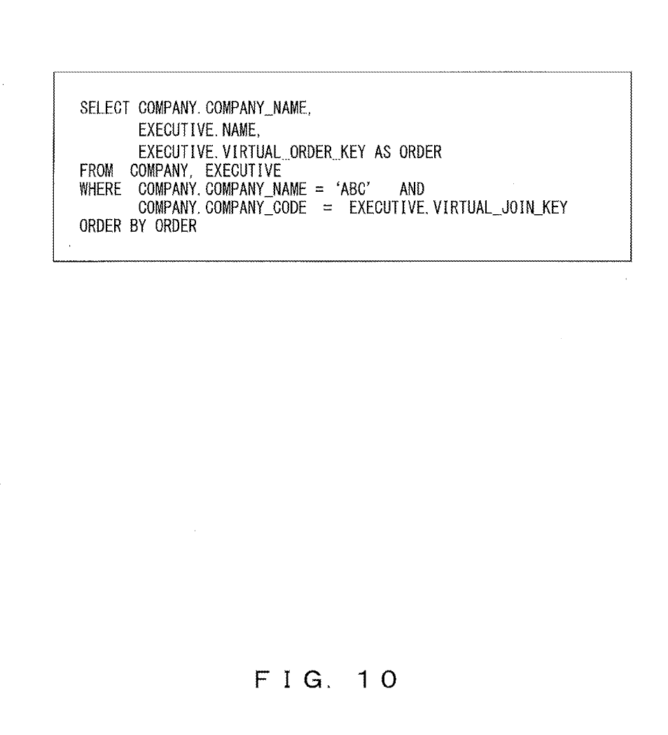

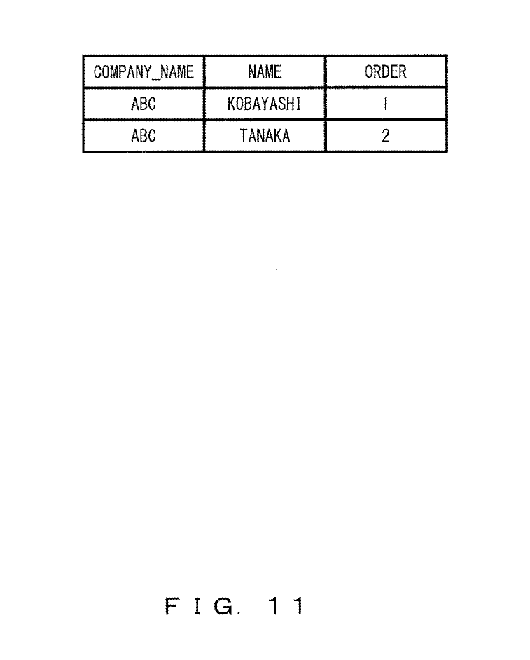

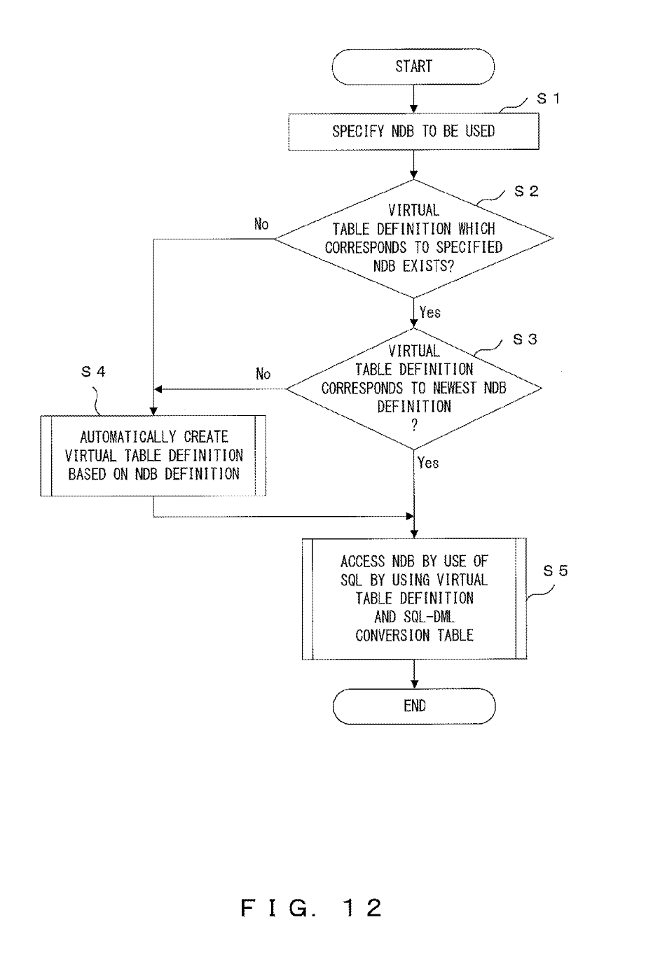

FIGS. 9A to 9C are examples of virtual tables which are recognized on a user side on the basis of the virtual table definition in FIG. 8. Through the virtual table definition 21, the information which is held in the NDB 22 looks, on the user side, as if it is managed in the virtual tables, that is, as if it is managed in the tables on a relational database, as illustrated in FIGS. 9A, 9B, and 9C.

This allows the user to access the virtual tables in FIGS. 9A, 9B, and 9C by use of an SQL statement so as to access the NDB 22, as is the case in the RDB.

Next is an example of how to use virtual tables. A virtual table (parent virtual table) corresponding to a parent record type and a virtual table (child virtual table) corresponding to a child record type are joined on the condition “parent unique key=child join key”. This permits associating of the parent virtual record and the child virtual record.

Further, using a virtual order key in the child virtual table permits representing of an order of child records so as to perform a manipulation by use of an SQL on the basis of the order of storing data, for example, in an NDB. In addition, since the parent unique key and the child virtual join key are associated by the foreign key, the user does not have to be aware of a child relationship between record types on the NDB.

Next is a description of data manipulation on virtual tables.

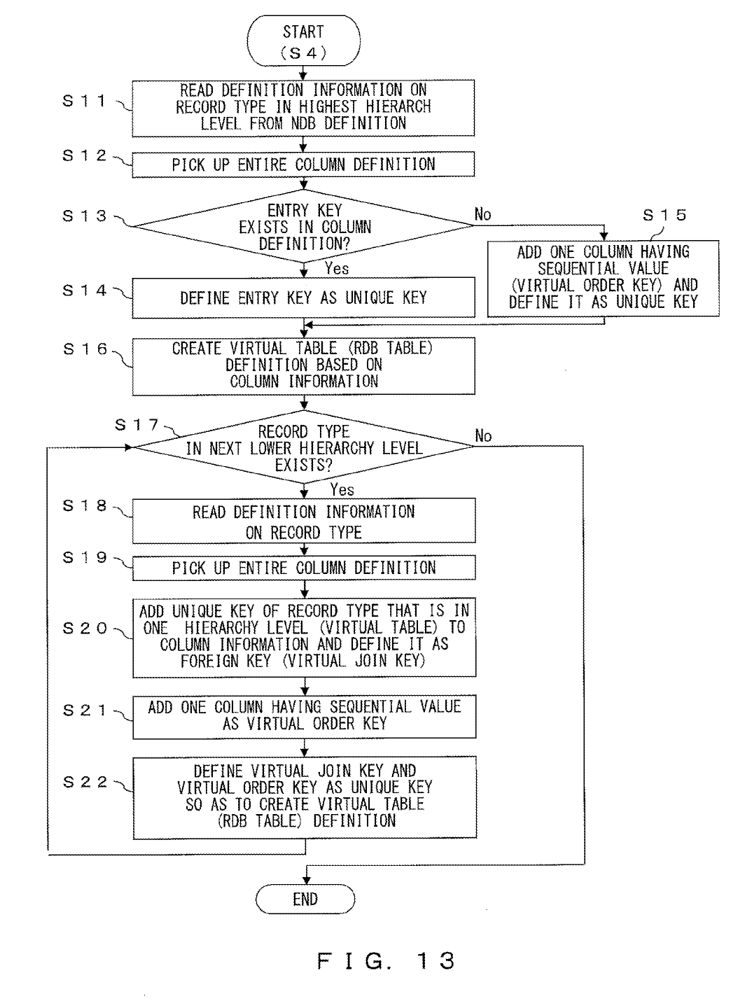

FIG. 10 is an example of an SQL for performing a data manipulation on virtual tables according to the embodiment (Example 1). For example, when a list of executives of the company named “ABC” is output from the virtual tables illustrated in FIGS. 9A and 9B, an SQL statement which is illustrated in FIG. 10 is executed.

Then, on a user side, the company named “ABC” looks as if it is extracted from the virtual table “COMPANY”, and the virtual tables “COMPANY” and “EXECUTIVE” about “ABC” look as if they are linked by the company code and the virtual join key of the virtual table “EXECUTIVE”. Further, from the linked tables, the records which have acquired the items of “COMPANY”, “NAME (of executives)”, and an order (which was formerly named “VIRTUAL ORDER KEY”) look as if they are acquired and output.

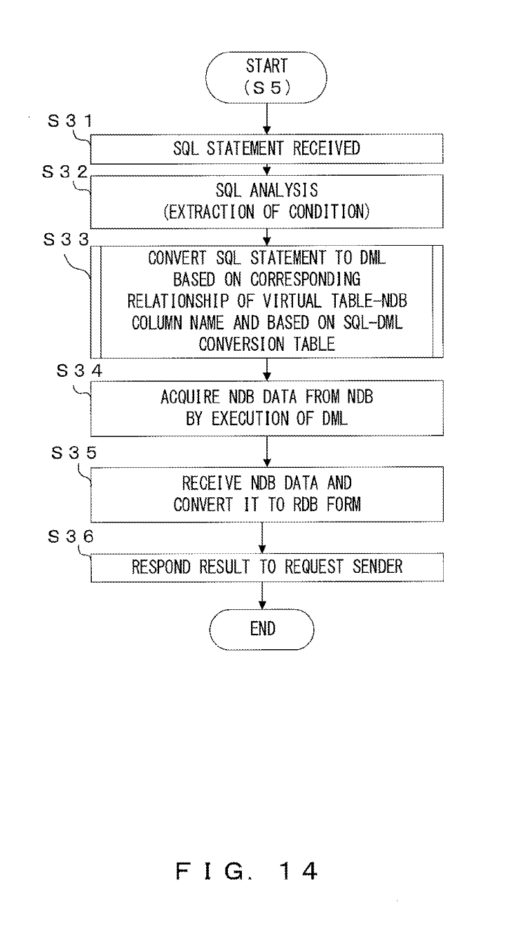

FIG. 11 is an example of a result of a query to the NDB by use of the SQL according to the embodiment (Example 1). As illustrated in FIG. 11, the result of the query to the NDB by use of the SQL in FIG. 10 can be obtained in the same table form as that of the query to the RDB. This permits acquiring of output data in the same interface as that of the RDB.

FIG. 12 is a flowchart of an operation procedure according to the embodiment (Example 1). Using the input-output device 12, the user specifies an NDB 22 on which a data manipulation is to be performed (S1). The user determines whether or not a virtual table definition 21 which corresponds to the specified NDB 22 exists in a storing device 19 (S2).

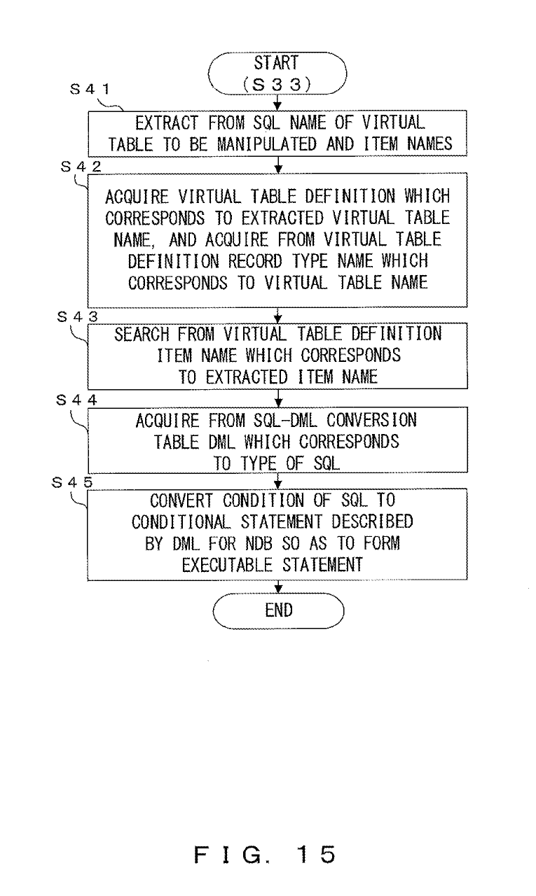

When the virtual table definition 21 which corresponds to the specified NDB does not exist in the storing device 19 (“No” in S2), the user inputs an instruction in the input-output device 12 to automatically generate the virtual table definition 21, on the basis of the NDB definition 24 (S4). The details of S4 will be described in FIG. 13.

When the virtual table definition 21 that corresponds to the specified NDB exists in the storing device 19 (“Yes” in S2), the user determines whether or not the virtual table definition 21 corresponds to the newest NDB definition (S3).

When the virtual table definition 21 does not correspond to the newest NDB definition (“No” in S3), the user inputs an instruction in the input-output device 12 to automatically generate the virtual table definition 21 on the basis of the NDB definition 24 (S4). The details of S4 will be described in FIG. 13.

When the virtual table definition 21 corresponds to the newest NDB definition (“No” in S3), or when the virtual table definition 21 has been generated in S4, the user proceeds to the next step. In other words, after the user inputs the SQL with the input-output device 12, the information processing apparatus 10 accesses the NDB 22 by using the virtual table definition 21 and the SQL-DML conversion table 20 (S5).

FIG. 13 is an example of a detailed flowchart of virtual table definition generating processing (S4) according to the embodiment (Example 1). The generator 15 acquires the NDB definition 24 from the NDB 22 and reads the definition information on the highest record type in the highest hierarchy level from the NDB definition 24 (S11).

From the read definition information on the record type in the highest hierarchy level, the generator 15 picks up an entire column definition of the record type (S12). Referring to the picked-up column definition, the generator 15 determines whether or not an entry key (a unique key) exists in the column definition (S13).

When the entry key exists in the picked-up column definition (“Yes” in S13), the generator 15 defines the entry key as a unique key (S14). When the entry key does not exist in the picked-up column definition (“No” in S13), the generator 15 adds one column having a sequential value (a virtual order key) to the column definition, and defines the value which is set to the column as a unique key (S15).

On the basis of the column information which has been adjusted in S14 or S15, the generator 15 creates the virtual table (RDB table) definition 21 using a CREATE statement (S16).

From the acquired NDB definition 24, the generator 15 determines whether or not the definition information on a record type in the next lower hierarchy level exists (S17). When the definition information on the record type in the next lower hierarchy level exists (“Yes” in S17), the generator 15 reads therein the definition information on the record type (S18).

From the definition information on the record type which was read in S18, the generator 15 picks up an entire column definition of the record type (S19).

To the column definition on the record type which was read in S18, the generator 15 adds the column information which has a unique key defined in the virtual table definition 21 corresponding to the record type that is in one hierarchy level higher than the record type read in S18, and defines the column information as a foreign key (S20). This column information added as a foreign key corresponds to a virtual join key.

The generator 15 further adds one column having a sequential value (a virtual order key) to the column definition (S21).

The generator 15 defines the virtual join key and the virtual order key which were added in S20 and S21 as unique keys so as to create the virtual table (RDB table) definition (S22).

This permits creating of the virtual table definition 21 for each record type from the record type in the highest hierarchy level down to the record types in lower levels, sequentially, by use of the NDB definition 24 stored in the NDB 22.

FIG. 14 is an example of a flowchart of query processing to the NDB according to the embodiment (Example 1). Using the input-output device 12, the user inputs an SQL statement (such as SELECT, UPDATE, DELETE, INSERT, and FETCH) for querying the NDB 22. As an example, the SQL illustrated in FIG. 10 is input. The reception unit 13 receives the SQL statement input from the input-output device 12 (S31).

The analyzer 14 analyzes the syntax of the received SQL statement and extracts the conditions written by use of an SQL (S32).

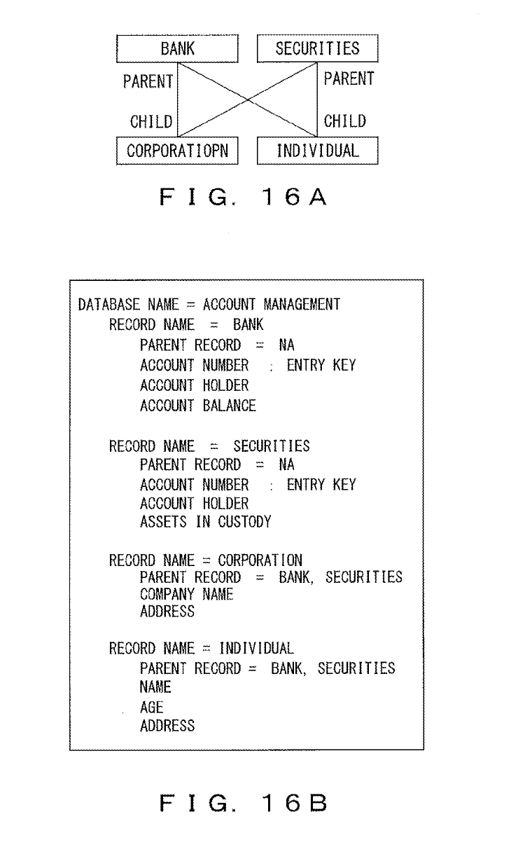

On the basis of a correspondence between a virtual table and an NDB column name and on the basis of the SQL-DML conversion table 20, the data converter 17 converts the analyzed SQL statement to a DML for NDB (S33). The process in S33 will be described in FIG. 15 in detail.

Using the converted DML for NDB, the data converter 17 performs an access request to the DBMS 25. According to the access request, the DBMS 25 executes the DML for NDB, picks up the NDB data from the NDB 22, and gives the NDB data to the execution unit 16. The data converter 17 receives the NDB data from the DBMS 25 (S34).

After receiving the NDB data from the DBMS 25, the data converter 17 converts the NDB data to RDB form (S35).

The execution unit 16 responds to the input-output device 12 by returning the RDB data obtained by conversion (S36).

FIG. 15 is an example of a flowchart of SQL-DML conversion processing (S33) according to the embodiment (Example 1). From the acquired SQL, the data converter 17 extracts a name of a virtual table to be manipulated (selection, update, insertion, and deletion, for example) and item names in the virtual table (S41).

From the storing unit 19, the data converter 17 acquires the virtual table definition 21 which corresponds to the extracted virtual table name, and, from the virtual table definition 21, acquires a record type name which corresponds to the virtual table name (S42). From the virtual table definition 21, the data converter 17 searches for an item which corresponds to the extracted item name (S43).

From the SQL-DML conversion table 20, the data converter 17 acquires a DML for NDB which corresponds to the type of SQLs (S44). The data converter 17 converts a conditional expression of an SQL to that of a DML for NDB (S45).

For example, when a record of an item A1=XXX (items A1 and B1) is extracted from the virtual tables AA and BB, the data converter 17 acquires an SQL statement “SELECT A1, B1 FROM AA, BB WHERE A1=XXX”. In this case, from the virtual join key of the virtual table definition 21, the data converter 17 identifies a relationship between the virtual tables AA and BB, that is, a parent-child relationship. Further, the data converter 17 moves a cursor from a parent record of a parent record type AA to a first record of a child record type BB by use of “MOVE”, and, from the child record, creates a DML which searches for a child record having the item A1=XXX by use of “GET ANY”.

For example, when the value of the item A1 in the record of the item A1=XXX is updated with Z, the data converter 17 acquires an SQL statement “UPDATE AA SET A1=Z WHERE A1=XXX”. In this case, the data converter 17 moves the cursor to a first record of the record type AA by use of “MOVE”, and searches for the record of the item A1=XXX and reads it therein by use of “GET ANY” and “GET NEXT” so as to create a DML which updates the value of A1 with Z by use of “MODIFY”.

For example, when the record of the item A1=XXX is deleted from the virtual table AA, the data converter 17 acquires an SQL statement “DELETE FROM AA WHERE A1=XXX”. In this case, the data converter 17 moves the cursor to the first record of the record type AA by use of “MOVE”, and searches for the record of the item A1=XXX and reads it therein by use of “GET ANY” and “GET NEXT” so as to create a DML which deletes the record by use of “ERASE”.

For example, when the record of the item A1=XXX is added to the virtual table AA, the data converter 17 acquires an SQL statement “INSERT INTO AA SELECT A1=XXX”. In this case, the data converter 17 moves the cursor to the first record of the record type AA by use of “MOVE”, and creates a DML which adds the record having the item A1=XXX to the first or last in a group of child records by use of “STORE”.

The data converter 17 forms the DML acquired in S44 and S45 and the converted conditional statement so as to be executable (S46).

According to the example 1, a data manipulation on an NDB can be performed by use of an SQL as if the data manipulation was performed on a table in an RDB. As a result, on a user side, the NDB can be used as an RDB without a data structure on the NDB or an interface regarding an input and output of the NDB being recognized.

### Example 2

In the example 1, the usage of a virtual table when one or more child record types exist for one parent record type has been described. On the other hand, the usage of a virtual table when one or more child record types exist for more than one parent record will be described in the example 2. For the configuration and the function of the information processing apparatus according to the example 2, the same configurations or functions as in the example 1 are designated by the same reference numerals and the description thereof is omitted.

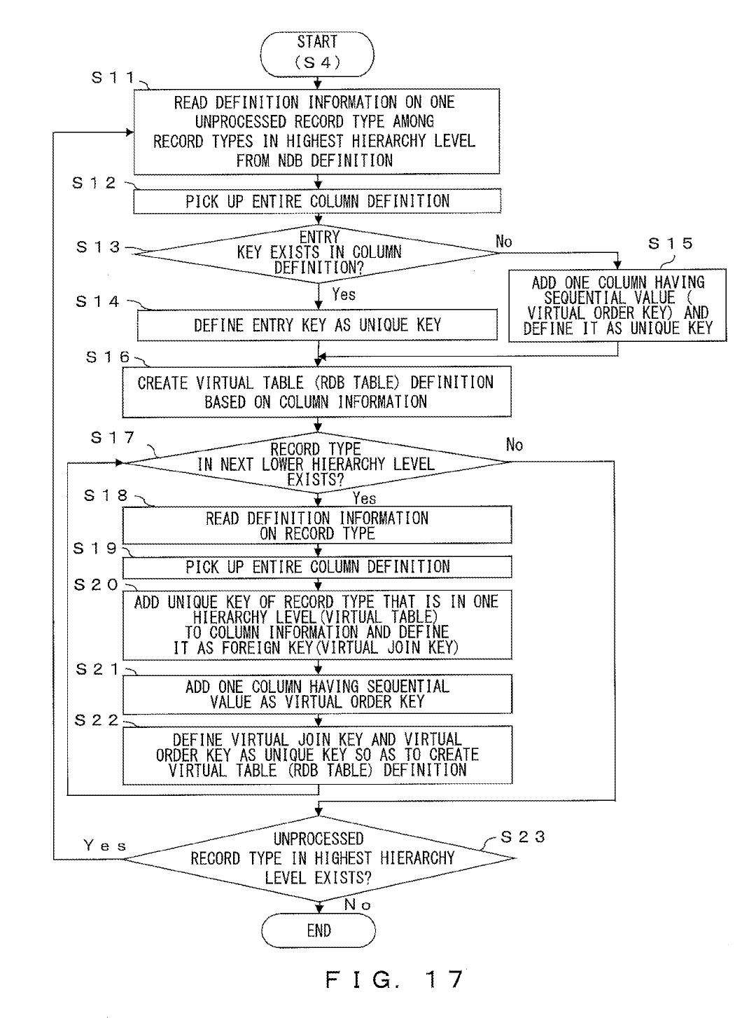

FIGS. 16A and 16B are illustrations of a data structure of an NDB when a plurality of child record types exist for a plurality of parent record types according to the embodiment (Example 2). FIG. 16A illustrates a pattern in which a plurality of child record types exist for a plurality of parent record types. There are two child record types “CORPORATION” and “INDIVIDUAL” for a parent record type “BANK”. In addition, there are two child record types “CORPORATION” and “INDIVIDUAL” for a parent record type “SECURITIES”.

In contrast, two parent record types “BANK” and “SECURITIES” exist for a child record type “INDIVIDUAL”. FIG. 16B illustrates item information for each record type in FIG. 16A. Further, two parent record types “BANK” and “SECURITIES” also exist for a child record type “CORPORATION”.

As described above, FIG. 16A illustrates a pattern “parent record type:child record type”=“N:N”. A pattern “parent record type:child record type”=“N:1” can be represented with three record types “BANK”, “SECURITIES”, and “INDIVIDUAL”, or “BANK”, “SECURITIES”, and “CORPORATION”. For the pattern “parent record type:child record type”=“N:1”, the flow of processes and the usage are the same as in “parent record type:child record type”=“N:N”.

Next is a description of a generation of the virtual table definition in the case of the relationship “parent record type:child record type”=“N:N”. Also, in the case of the relationship “parent record type:child record type”=“N:N”, the virtual table definition is generated by use of the flowchart in FIG. 13. In this case, the flow in FIG. 13 is performed for each of the record types in the highest hierarchy level.

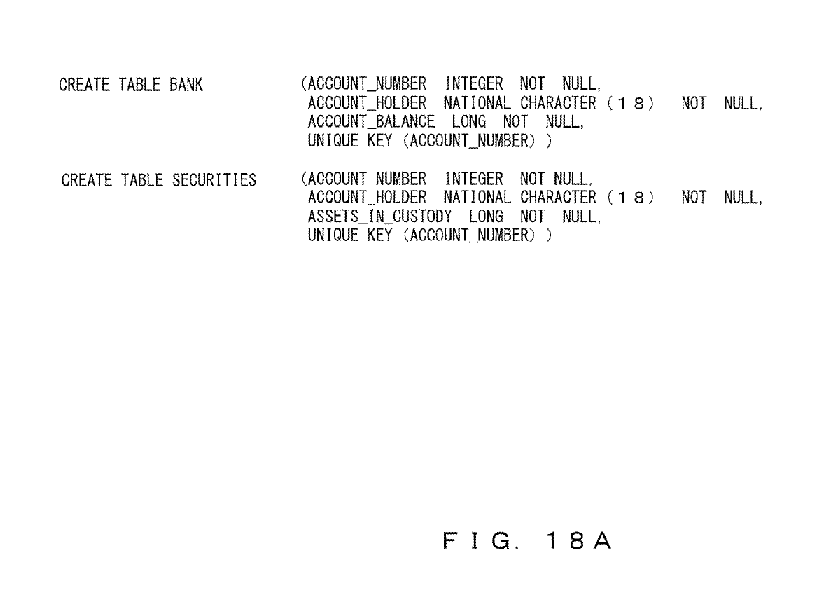

FIG. 17 is an example of a detailed flowchart of virtual table definition generating processing (S4) according to the embodiment (Example 2). In S4, the processes in the example 2 that are different from that in the first process will now be described, and the rest is the same as in the example 1.

The generator 15 acquires the NDB definition 24 from the NDB 22, and from the NDB definition 24, reads the definition information on one unprocessed record type from among the record types in the highest hierarchy level (S11a). After that, S12 to S22 in FIG. 13 are performed. This permits creating of the virtual table definition for each record type from one record type in the highest hierarchy level down to the record types in lower levels, sequentially.

When an unprocessed record type in the highest hierarchy level exists in the NDB definition 24 (“Yes” in S23), the generator 15 acquires the definition information on the next unprocessed record type in the highest hierarchy level from the NDB definition 24 (S11a), and performs the processes from S12 through S22.

For all the record types in the highest hierarchy level, the generator 15 performs processing from S12 through S22.

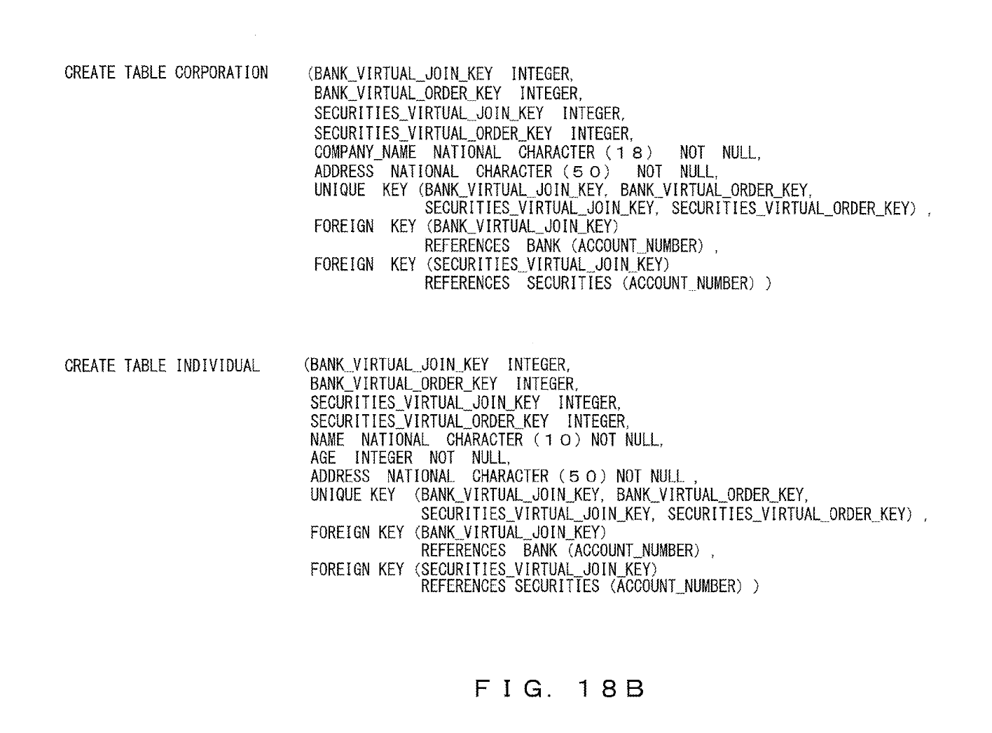

FIGS. 18A and 18B are an example of a virtual table definition which is generated in the case of the relationship “parent record type:child record type”=“N:N” according to the embodiment (Example 2). The virtual table definitions in FIGS. 18A and 18B are generated by the processes of FIG. 17 with respect to the data structure of the NDB illustrated in FIGS. 16A and 16B.

As illustrated in FIGS. 18A and 18B, in the case of the relationship “parent record type:child record type”=“N:N”, the virtual table definition of the parent record type is the same as in the case of “parent record type:child record type”=“1:N”. However, a virtual join key and a virtual order key are included in the virtual table definition of the child record types for each parent record type.

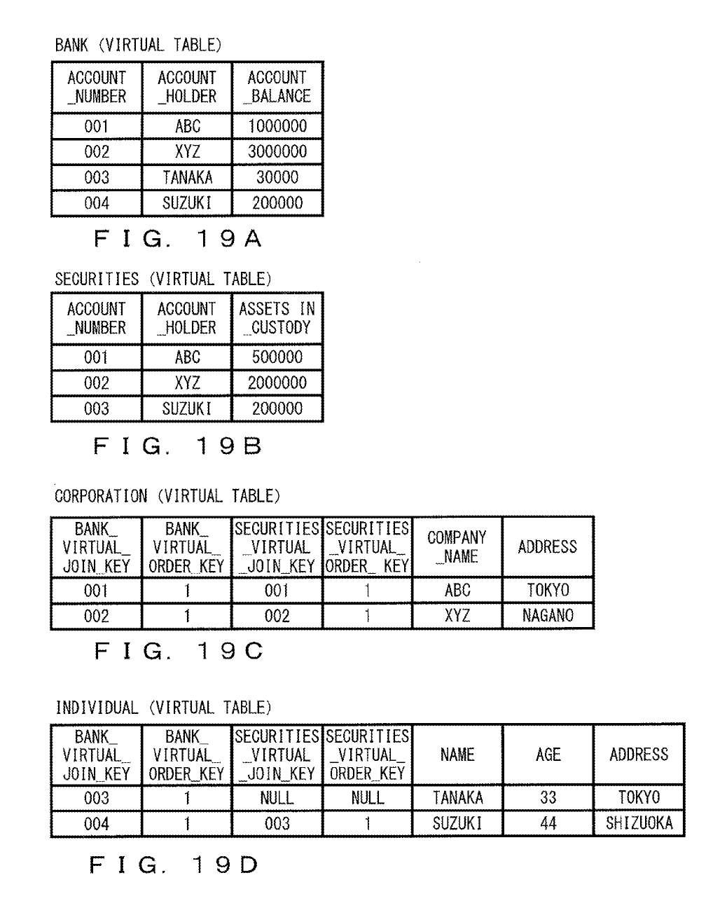

FIGS. 19A to 19D are examples of virtual tables which are recognized on a user side on the basis of the virtual table definitions in FIGS. 18A and 18B. On the basis of the virtual table definition in FIGS. 18A and 18B, the NDB database looks like that in FIGS. 19A to 19D. The usage of the virtual tables are the same as in the case of “1:N”.

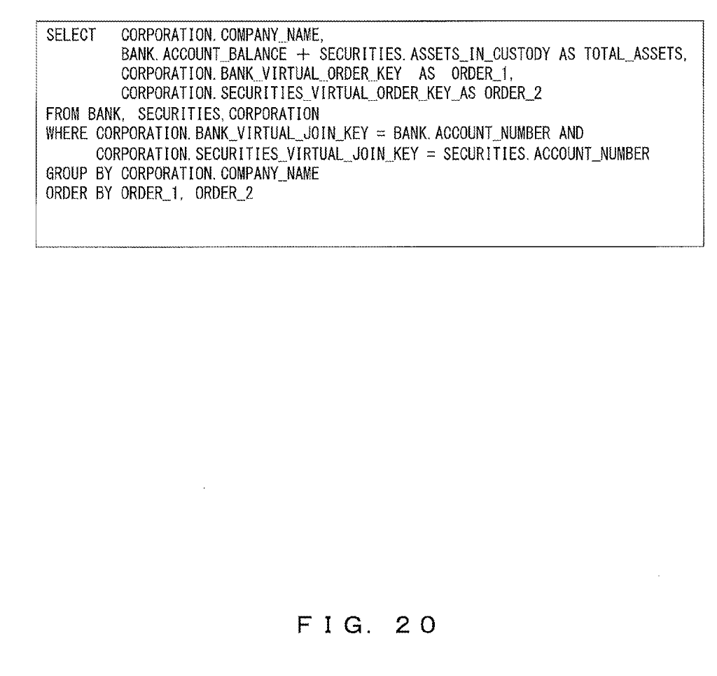

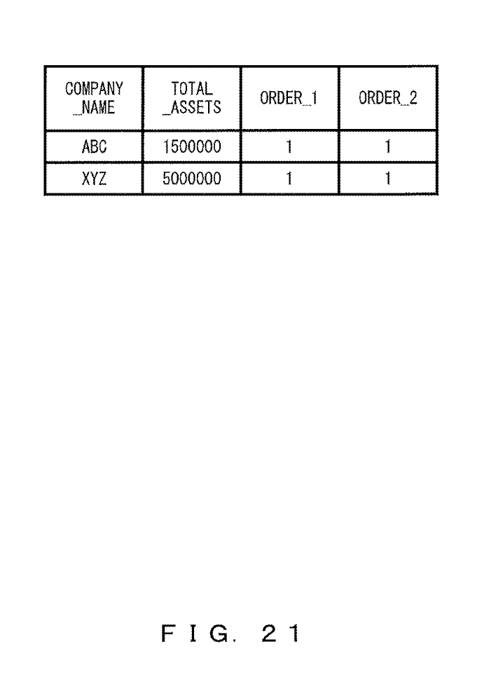

Next is a description on an example of how to use virtual tables in the case of the relationship “parent record type:child record type”=“N:N”, referring to FIGS. 20 and 21.

FIG. 20 is an example of an SQL for performing a data manipulation on the virtual tables according to the embodiment (Example 2). For example, when the total assets are output for each corporation, the SQL statement in FIG. 20 is executed.

FIG. 21 is an example of a result of a query to the NDB by use of the SQL according to the embodiment (Example 2). When the SQL statement in FIG. 20 is executed, the result in the FIG. 21 is obtained.

According to the example 2, likewise for a data structure of an NDB in which a plurality of child record types exist for a plurality of parent record types, the virtual table definition can be created, as is the case in the example 1. This permits a data manipulation of an NDB by use of an SQL regardless of a data structure of an NDB.

According to the embodiment (Examples 1 and 2), the SQL is converted to a DML for NDB by use of the relationship definition in which the parent-record-type record identifying information and the child record ordering information are added to the items of the record types. This permits increasing of a freedom of a data manipulation on the NDB 22 by the SQL. On a user side, a data manipulation can be performed on the NDB by use of an interface of the RDB without awareness of a data structure of the NDB and a number of columns in the record types, for example. Regarding a relationship between record types, those can be dealt with as if virtual tables were joined by use of a virtual join key. Since the child records are managed by a virtual order key, the user can also deal with a data manipulation in accordance with an order of the child records in the NDB that is performing a data manipulation on the virtual tables.

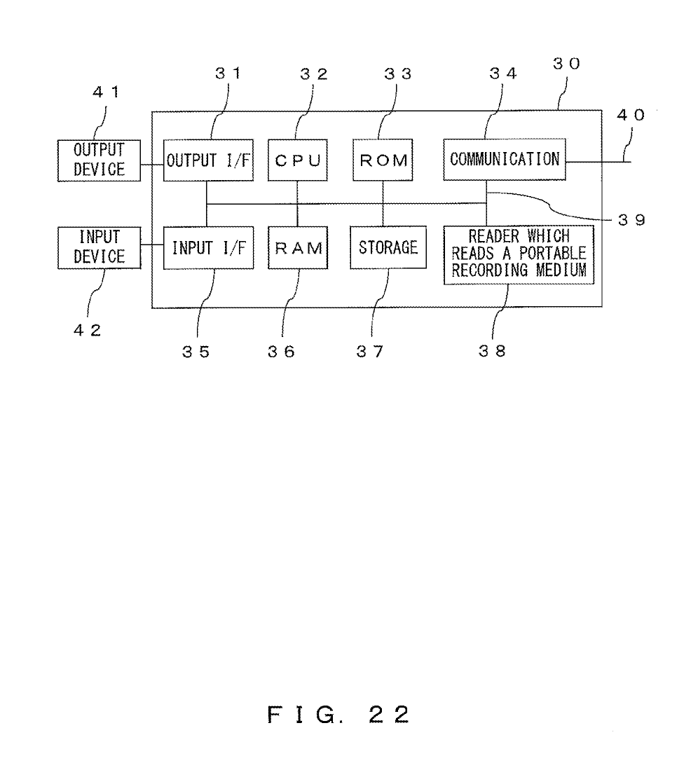

FIG. 22 is an example of a configurative block diagram of a hardware environment of a computer which executes the program in the examples 1 and 2. The computer 11 includes a CPU 32, a ROM. 33, a RAM. 36, a communication I/F 34, a storage 37, an output I/F 31, an input I/F 35, a reader 38, a bus 39, an output device 41, and an input device 42.

Herein, CPU indicates a central processing unit. ROM indicates a read only memory. RAM indicates a random access memory. I/F indicates an interface. The CPU 32, the ROM 33, the RAM 36, the communication I/F 34, the storage 37, the output I/F 31, the input I/F 35, and the reader 38 are connected to the bus 39. The reader 38 reads a portable recording medium. The output device 41 is connected to the output I/F 31. The input device 42 is connected to the input I/F 35.

As the storage 37, storages in various forms such as a hard disk, a flash memory, and a magnetic disk can be used. The storage 37 or the ROM 33 stores thereon a program which allows the CPU 32 to function as the SQL conversion control unit 11, the NDB 22, the SQL-DML conversion table 20, and the virtual table definition 21, for example.

The CPU 32 reads the program which realizes the processes stored on, for example, the storage 37 that has been described in the above the embodiment, so as to execute the program.

The program which realizes the processes described in the above embodiment may be stored on, for example, the storage 37 by a provider through a communication network 40 and the communication I/F 34. Further, the program which realizes the processing described in the above embodiment may be stored in a portable recording medium which is commercially available and distributed. In this case, the portable recording medium may be set to the reader 38 so that the program is read and executed by the CPU 32. As a portable recording medium, recording media in various forms such as a CD-ROM, a flexible disk, an optical disk, a magneto-optical disk, an IC card, and a USB memory can be used. The program stored on such a recording medium is read by the reader 38.

Further, a keyboard, a mouse, an electronic camera, a web camera, a microphone, a scanner, a sensor, and a tablet, for example, can be used as the input device 42. A display, a printer, and a speaker, for example, can be used as the output device 41. Further, the network 40 may be communication networks such as the Internet, a LAN, a WAN, an exclusive line, a fixed line, and a wireless.

The technology for a database access control according to the embodiment permits increasing of a freedom of a data manipulation on an NDB by SQL.

The embodiment is not limited to the above mentioned embodiments but is amenable to various configurations or embodiments without departing from the scope of the invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored thereon a program for causing a computer to execute processes for controlling a database access, the processes comprising:
acquiring first manipulation information formed by a first data manipulation language for a plurality of record types on which a data manipulation is to be performed, in a network-type database having a data structure in which a parent-child relationship is formed between record types;
analyzing a relationship between the plurality of record types by using relationship definition information which was acquired from a storing unit storing therein the relationship definition information in which item information, parent information and ordering information are defined for each record type, the item information being included in the record types, the parent information identifying a parent record whose record type is a parent record type of the record types, the ordering information indicating an order of child records that belong to the parent record;
generating second data manipulation information formed by a second data manipulation language for the network-type database, on the basis of the analyzed relationship and the first manipulation information; and
outputting the generated second data manipulation information to the network-type database.

2. The non-transitory computer-readable recording medium according to claim 1, the processes further comprising:
acquiring database definition information in which a data structure of the network-type database is defined;
extracting the item information of the record type for the each record type from the acquired database definition information; and
generating the relationship definition information in which the parent identifying information and child ordering information are added to the extracted item information.

3. The non-transitory computer-readable recording medium according to claim 1, wherein when a plurality of parent record types exist as the record type, the parent identifying information and the child ordering information are added to the relationship definition information for the each parent record type.

4. An information processing apparatus comprising:
a storing unit that stores relationship definition information in which item information, parent information and ordering information are defined for each record type, the item information being included in record types, the parent information identifying a parent record whose record type is a parent record type of the record types, the ordering information indicating an order of child records that belong to the parent record; and
a processor that performs processes including:
acquiring first manipulation information formed by a first data manipulation language for a plurality of record types on which a data manipulation is to be performed, in a network-type database having a data structure in which a parent-child relationship is formed between record types;
analyzing a relationship between the plurality of record types by using the relationship definition information which was acquired from the storing unit;
generating second data manipulation information formed by a second data manipulation language for the network-type database, on the basis of the analyzed relationship and the first manipulation information; and
outputting the generated second data manipulation information to the network-type database.

5. The information processing apparatus according to claim 4, the information processing apparatus further comprising:
acquiring database definition information in which a data structure of the network-type database is defined;
extracting the item information of the record type for the each record type from the acquired database definition information; and
generating the relationship definition information in which the parent identifying information and child ordering information are added to the extracted item information.

6. The information processing apparatus according to claim 4, wherein when a plurality of parent record types exist as the record type, the parent identifying information and the child ordering information are added to the relationship definition information for the each parent record type.

7. A method for controlling a database access, the method comprising:
acquiring, by using a computer, first manipulation information formed by a first data manipulation language for a plurality of record types on which a data manipulation is to be performed, in a network-type database having a data structure in which a parent-child relationship is formed between record types;
analyzing, by using the computer, a relationship between the plurality of record types by use of relationship definition information which was acquired from a storing unit storing therein the relationship definition information in which item information, parent information and ordering information are defined for each record type, the item information being included in the record types, the parent information identifying a parent record whose record type is a parent record type of the record types, the ordering information indicating an order of child records that belong to the parent record;
generating, by using the computer, second data manipulation information formed by a second data manipulation language for the network-type database, on the basis of the analyzed relationship and the first manipulation information; and
outputting, by using the computer, the generated second data manipulation information to the network-type database.

8. The method according to claim 7, the method further comprising:
acquiring, by using the computer, database definition information in which a data structure of the network-type database is defined;
extracting, by using the computer, the item information of the record type for the each record type from the acquired database definition information; and
generating, by using the computer, the relationship definition information in which the parent identifying information and child ordering information are added to the extracted item information.

9. The method according to claim 7, wherein when a plurality of parent record types exist as the record type, the parent identifying information and the child ordering information are added to the relationship definition information for the each parent record type.
